(19) United States
(12) Patent Application Publication
(10) Pub. No.: US 2008/0052916 A1
(43) Pub. Date: Mar. 6, 2008

(54) Tree pruner

(76) Inventor: Thomas Lin, Taichung County (TW)

Correspondence Address: BROWDY AND NEIMARK, P.L.L.C.;624 NINTH STREET, NW, SUITE 300, WASHINGTON, DC, 20001-5303, US

(21) Appl. No.: 11/646,262

(22) Filed: Dec. 28, 2006

(30) Foreign Application Priority Data
Sep. 6, 2006 (TW) 95215851

(51) Int. Cl. B26B 13/00

(52) U.S. Cl. 30/249

(57) ABSTRACT

A tree pruner includes a stationary cutting blade mounted on a handle, a driving bar moveably engaged with the stationary cutting blade and moveable by a pull cord, a spring member connected between the stationary cutting blade and the driving bar, a movable cutting blade pivotally mounted on the stationary cutting blade and the driving bar and moveable relative to the stationary cutting blade by the actuation of the driving bar; and a positioning member pivotally mounted on the stationary cutting blade and pivotable between a first position where the positioning member is engaged with the driving bar such that the driving bar can not drive the moveable cutting blade to move and a second position where the positioning member is disengaged with the driving bar such that the driving bar is moveable to drive the moveable cutting blade to move relative to the stationary cutting blade.

### BACKGROUND OF THE INVENTION

1. Field of the Invention

The present invention relates generally to a gardening implement, and more specifically to a tree pruner.

2. Description of the Related Art

A conventional tree pruner comprises a handle, a pair of scissors pivotally mounted on the handle, and a pull cord connected with the handle and the scissors. When the tree pruner is in use, the user can draw the pull cord to control the action of the scissors to clip tree sticks.

However, when the operator draws the pull cord unintentionally, the suddenly clipping action of the scissors may hurt somebody's hand or body placed around the two cutting edges of the scissors. Therefore, it is a need to provide a safety mechanism for the tree pruner.

### SUMMARY OF THE INVENTION

The present invention has been accomplished under the circumstances in view. It is one objective of the present invention to provide a tree pruner, which has good safety in use.

To achieve this objective of the present invention, the tree pruner comprises a handle, a stationary cutting blade, a driving bar, a pull cord, a movable cutting blade, a spring member and a positioning member. The handle is mounted with a first pulley. The stationary cutting blade is mounted on the handle and has a transmission teeth portion. The driving bar is mounted with a second pulley and provided with a driving teeth portion engaged with the transmission teeth portion, and a positioning portion. The pull cord is connected with the handle and runs over the first pulley and the second pulley such that the pull cord is pullable to move the driving bar. The spring member has one end fastened to the stationary cutting blade and the other end fastened to the driving bar. The movable cutting blade is pivotally mounted on the stationary cutting blade and the driving bar and moveable relative to the stationary cutting blade by the driving bar. The positioning member is pivotally mounted on the stationary cutting blade and pivotable between a first position where the positioning member is engaged with the positioning portion of the driving bar to lock the driving bar such that the driving bar can not drive the moveable cutting blade to move relative to the stationary cutting blade and a second position where the positioning member is disengaged with the positioning portion of the driving bar such that the driving bar is moveable by the pull cord to drive the moveable cutting blade to move relative to the stationary cutting blade.

In a preferred embodiment of the present invention, the positioning member has a hook engageable with the positioning portion of the driving bar, and a tab pushable by the user's finger to move the positioning member between the first position and the second position.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a front view of a part of the tree pruner according to a preferred embodiment of the present invention;

FIG. 2 is a rear view of FIG. 1, showing that the driving bar is locked by the positioning member;

FIG. 3 is similar to FIG. 1, but showing that the positioning member is pivoted away from the driving bar to unlock the driving bar, and

FIG. 4 is a schematic drawing showing the tree pruner in accordance with the preferred embodiment of the present invention at work.

### DETAILED DESCRIPTION OF THE INVENTION

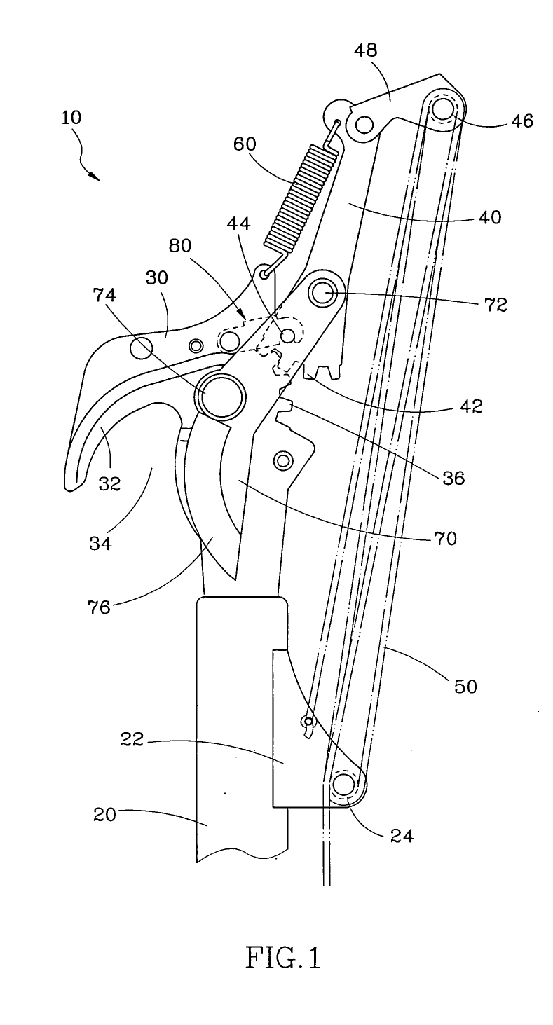

As shown in FIG. 1, a tree pruner, denoted by numeral reference 10, in accordance with a preferred embodiment of the present invention comprises a handle 20, a stationary cutting blade 30, a driving bar 40, a pull cord 50, a spring member 60, a movable cutting blade 70, and a positioning member 80.

The handle 20 has a protruded mounting portion 22 in which two first pulleys 24 are pivotally disposed.

The stationary cutting blade 30 has a bottom end firmly inserted in a top end of the handle 20. The stationary cutting blade 30 has a cutting edge 32 curvedly extending from one side of the stationary cutting blade 30 such that a mouth 34 is formed between a part of the stationary cutting blade 30 and the cutting edge 32. Further, the stationary cutting blade 30 is provided with a transmission teeth portion 36 at the side opposite to the cutting edge 32.

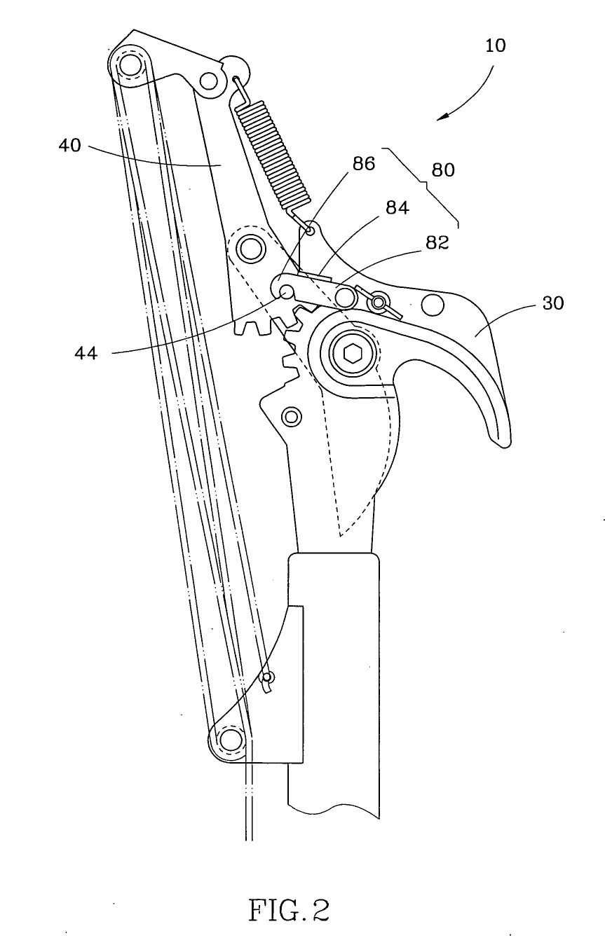

The driving bar 40 is provided at a bottom end thereof a driving teeth portion 42 engaged with the transmission teeth portion 36 of the stationary cutting blade 30. The driving bar 40 has a positioning portion 44 close to the driving teeth portion 42. The positioning portion 44 is a protrusion, as shown in FIG. 2. In addition, the driving bar 40 is provided at a top side thereof with an arm 48 in which two second pulleys 46 are mounted.

The pull cord 50 has an end fastened to the mounting portion 22 of the handle 20, a body portion running over the first pulleys 24 and the second pulleys 46, and the other end (not shown) positioned to the bottom end of the handle 20.

The spring member 60, which is a tensile spring in this embodiment, has two opposite ends respectively fastened to a top end of the stationary cutting blade 30 and the top side of the driving bar 40 for providing a rebound force.

The movable cutting blade 70 has an end pivotally mounted on the driving bar 40 by a first pivot 72, a middle portion pivotally mounted on the stationary cutting blade 30 by a second pivot 74, and a side defining a cutting edge 76.

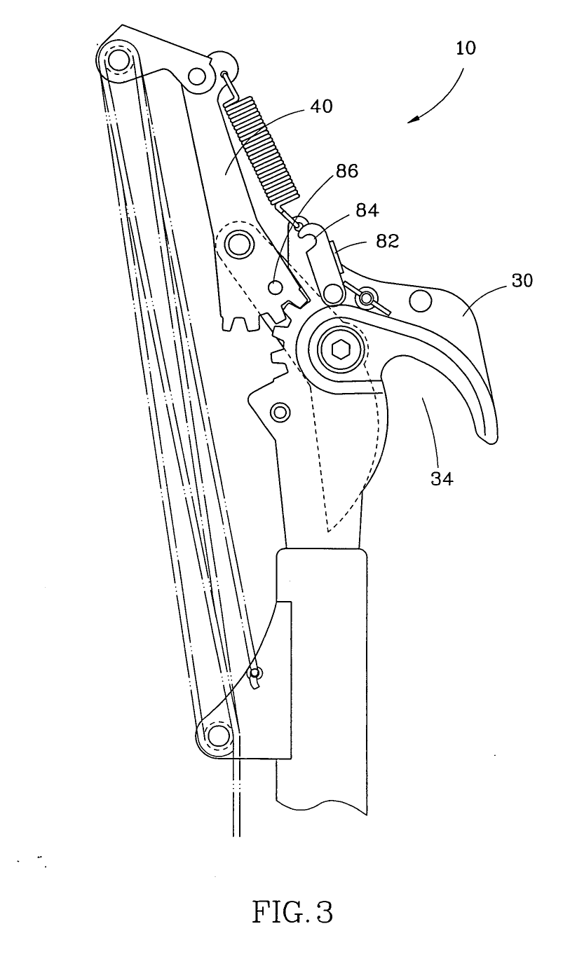

As shown in FIG. 2, the positioning member 80 has an end pivotally fastened to the stationary cutting blade 30 such that the positioning member 80 is pivotable between a first position as shown in FIG. 2 and a second position as shown in FIG. 3, the other end defining a hook 86, and a tab 84, which protrudes from one side of the positioning member 80 and is pushable by user's finger to move the positioning member 80 between the first position and the second position. When the positioning member 80 is located at the first position as shown in FIG. 2, the hook 86 of the positioning member 80 is engageable with the positioning portion 44 of the driving bar 40 to lock the driving bar 40 such that the driving bar 40 can not move, which in turn can not drive the moveable cutting blade 70 to move relative to the stationary cutting blade 30. When the positioning member 80 is located at the second position as shown in FIG. 3, the hook 86 of the positioning member 80 is moved away from the positioning portion 44 of the driving bar 40 so as to unlock the driving bar 40 such that the moveable cutting blade 70 can be driven by the driving bar 40 to move toward the stationary cutting blade 30 for cutting. The operation of the tree pruner 10 of the present invention will be detailed described hereinbelow.

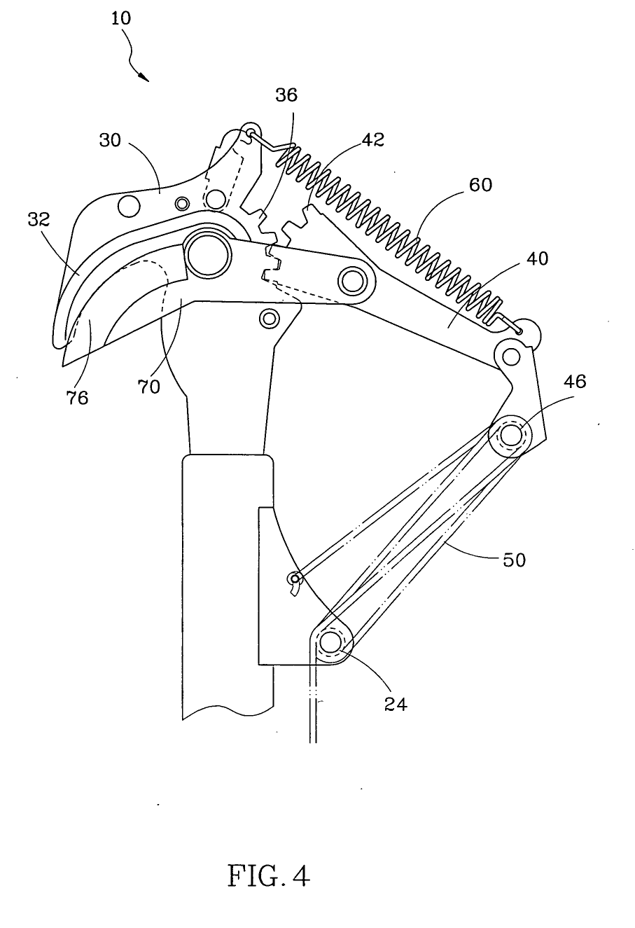

Now referring to FIG. 3 and FIG. 4, when a user wants to use the tree pruner 10 to cut tree sticks, the user can push the tab 84 of the positioning member 80 to move the hook 86 away from the positioning portion 44 of the driving bar 40, as shown in FIG. 3, and let the to-be-cut tree sticks be placed in the mouth 34 of the stationary cutting blade 30. Thereafter, the user can pull the pull cord 50 to drive the driving bar 40 to swivel clockwise about the first pivot 72. As a result, the cutting edge 76 of the movable cutting blade 70 is moved toward the cutting edge 32 of the stationary cutting blade 30 to cut the tree sticks placed in the mouth 34 by means of the actuation of the driving bar and the engagement of the transmission teeth portion 36 and the driving teeth portion 42. When the cutting action is completed, the driving bar 40 is allowed to swivel back to its initial position due to the rebound force of the spring member 60 by loosing the pull cord 50, resulting in that the cutting edge 76 of the movable cutting blade 70 is moved away from the cutting edge 32 of the stationary cutting blade 30. At this stage, the user can push the tab 84 of the positioning member 80 to make the hook 86 of the positioning member 80 engage with the positioning portion 44 of the driving bar 40 to lock the driving bar 40 in position, such that the moveable cutting blade 70 can not be driven by the driving bar 40 to move relative to the stationary cutting blade 30 because the driving bar 40 is not moveable at this status. Under this circumstance, even if the user unintentionally pulls the pull cord 50, since the driving bar 40 is locked, the cutting action of the tree pruner 10 is prohibited, thereby preventing an accident that could be happened due to suddenly cutting action. In other words, the tree pruner 10 of the present invention can provide good safety in use.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A tree pruner comprising:
a handle mounted with a first pulley;
a stationary cutting blade mounted on the handle and provided with a transmission teeth portion;
a driving bar mounted with a second pulley and provided with a driving teeth portion engaged with the transmission teeth portion, and a positioning portion;
a pull cord connected with the handle and running over the first pulley and the second pulley such that the pull cord is pullable to move the driving bar;
a spring member having one end fastened to the stationary cutting blade and the other end fastened to the driving bar;
a movable cutting blade pivotally mounted on the stationary cutting blade and the driving bar and moveable relative to the stationary cutting blade by the driving bar; and
a positioning member pivotally mounted on the stationary cutting blade and pivotable between a first position where the positioning member is engaged with the positioning portion of the driving bar to lock the driving bar such that the driving bar can not drive the moveable cutting blade to move relative to the stationary cutting blade and a second position where the positioning member is disengaged with the positioning portion of the driving bar such that the driving bar is moveable to drive the moveable cutting blade to move relative to the stationary cutting blade.

2. The tree pruner as claimed in claim 1, wherein the positioning portion is a protrusion, and the positioning member has a hook engageable with the protrusion when the positioning member is located at the first position.

3. The tree pruner as claimed in claim 2, wherein the positioning member has a tab pushable by the user to move the positioning member between the first position and the second position.
